(19) United States
(12) Patent Application Publication
(10) Pub. No.: US 2024/0124077 A1
(43) Pub. Date: Apr. 18, 2024

(54) VEHICLE CAPABLE OF CONTAINER SWAPPING

(71) Applicants: Hyundai Motor Company, Seoul (KR); Kia Corporation, Seoul (KR)

(72) Inventors: Dong Eun CHA, Hwaseong-si (KR); Han Sam KIM, Hwaseong-si (KR); Tae Kyung LEE, Uiwang-si (KR); Dae Hee LEE, Incheon (KR); Jin Ho HWANG, Cheonan-si (KR); Jun Gu LEE, Incheon (KR); Sang Heon LEE, Seoul (KR)

(73) Assignees: Hyundai Motor Company, Seoul (KR); Kia Corporation, Seoul (KR)

(21) Appl. No.: 18/144,384

(22) Filed: May 8, 2023

(30) Foreign Application Priority Data
Oct. 14, 2022 (KR) 10-2022-0132527

(51) Int. Cl. B62D 63/02; B60R 16/033; B62D 9/00; B62D 25/06

(52) U.S. Cl. CPC B62D 63/025; B60R 16/033; B62D 9/00; B62D 25/06

(57) ABSTRACT

A vehicle configured for container-swapping, includes: a main frame including a pair of drive modules spaced in a forward/backward direction of the vehicle, and a connecting portion extending in the forward/backward direction of the vehicle to connect the pair of drive modules so that a coupling space is formed therebetween; a container module selectively inserted into the coupling space of the main frame; and a coupling portion configured to couple the main frame and the container to each other while the container module is inserted into the coupling space of the main frame, wherein a driving portion operates and moves the main frame so that the container module is inserted into the coupling space of the main frame.

### CROSS-REFERENCE TO RELATED APPLICATION(S)

The present application claims priority to Korean Patent Application No. 10-2022-0132527, filed on Oct. 14, 2022, the entire contents of which is incorporated herein for all purposes by this reference.

### BACKGROUND OF THE PRESENT DISCLOSURE

### Field of the Present Disclosure

The present disclosure relates to a vehicle configured for container-swapping, and more particularly, to a technology regarding a vehicle including a drive module which may be coupled to a container such that, as the drive module moves, the same may be coupled to a container.

### DESCRIPTION OF RELATED ART

Containers, particularly containers for ships which may be transported on roads are important items generally used for ships and cargo vehicles. In some cases, containers for ships have wheels disposed on the lower portion thereof, and may be fixed in a form of trailers configured to be towed behind towing vehicles, such as tractor trailers. Such trailers frequently need to move backwards toward loading docks configured to compensate for the height of containers increased by wheels so that cargo may be conveniently loaded and unloaded. Such a configuration causes inconvenience and/or additional work when loading and unloading cargo with regard to the ground, making it difficult to handle cargo, and may require additional equipment (for example, a forklift) for handling cargo. Such a trailer-type container may have difficulty or inconvenience in terms of storage and/or shipping because of the additional structure and the need to handle a trailer component attached to the container.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle including a main frame including drive modules disposed symmetrically in the longitudinal direction of the vehicle, driving portions provided in the drive modules, and a connecting portion configured to connect the drive modules so that the main frame and a container module are coupled to each other by movements of the drive modules, facilitating container module swapping.

A vehicle configured for container-swapping according to an exemplary embodiment of the present disclosure may include: a main frame including a pair of drive modules spaced in a longitudinal direction of the vehicle, and a connecting portion extending in the longitudinal direction of the vehicle to connect the pair of drive modules so that a coupling space is formed therebetween; a container module selectively inserted into the coupling space of the main frame; and a coupling portion configured to couple the main frame and the container module to each other while the container module is inserted into the coupling space of the main frame, wherein a driving portion operates and moves the main frame so that the container module is inserted into the coupling space of the main frame.

The connecting portion may be configured to connect upper end portions of the pair of drive modules, and the main frame may further include a pair of bent portions bent in a predetermined direction from first and second end portions of the connecting portion and to contact front and rear portions of the container module, respectively.

The main frame may further include a pair of extension portions extending from end portions of the pair of bent portions toward bumper portions of the drive modules, respectively.

The main frame may further include a reinforcement portion extending in a longitudinal direction of the vehicle to additionally connect the drive modules.

Multiple connecting portions may be formed to be spaced apart in a transverse direction of the vehicle, connecting the drive modules.

The main frame may include a barrier portion formed such that, when the container module is coupled, front and rear surfaces of the container module make contact therewith.

The vehicle may include coupling portions formed on facing surfaces of the drive modules and the container module, respectively, and the vehicle may include insertion grooves formed on one of the drive modules and the container module and actuators formed on the other to operate to be inserted into the insertion grooves.

The insertion grooves may be provided on the container module, and the actuators may be provided on the drive modules.

The coupling portions may be provided on corner portions of facing surfaces of the drive modules and the container module, respectively.

The driving portion may be formed as an independent driving module.

The driving portion may include a steering device configured to rotate a vehicle wheel around a rotation axis thereof in an upward/downward direction so that the vehicle can travel laterally.

The driving portion may include a vehicle height adjusting portion configured to adjust the vehicle height of the main frame such that, when the container module and the main frame are coupled, the vehicle height adjusting portion lowers the vehicle height, and when the container module and the main frame are fully coupled, the vehicle height adjusting portion raises the vehicle height.

The drive module may have an indoor space configured to accommodate a passenger or a battery for supplying power to the driving portion.

The vehicle may further include a roof panel extending in the forward/backward direction of the vehicle to cover the upper portion of the main frame.

The coupling portion may be configured to electrically connect the main frame and the container module.

A vehicle configured for container-swapping according to an exemplary embodiment of the present disclosure is advantageous as follows: the vehicle has a main frame including drive modules disposed symmetrically in the forward/backward direction of the vehicle, driving portions provided in the drive modules to be configured to travel laterally, and a connecting portion configured to connect upper portions of the drive modules so that a container module is inserted between the drive modules through lateral traveling and is coupled by a coupling portion. Accordingly, the main frame may be moved and coupled to the container module without a separate device for moving the container module.

Furthermore, an impact force applied to one of the drive modules during a vehicle collision is transferred to the other drive module, distributing the impact force applied to the vehicle and protecting the chassis and passengers.

Furthermore, a container is disposed between a pair of drive modules, and a connecting portion is disposed on the upper portion thereof. Accordingly, the center of gravity of the vehicle is disposed at the center, improving traveling stability of the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view of a vehicle configured for container-swapping according to an exemplary embodiment of the present disclosure;

FIG. 2 is a perspective view of a vehicle configured for container-swapping according to an exemplary embodiment of the present disclosure, the container module and main frame of which are separated from each other;

FIG. 3 is a top view exemplarily illustrating a process of coupling the container module and main frame of a vehicle configured for container-swapping according to an exemplary embodiment of the present disclosure;

FIG. 4 and FIG. 5 are perspective views of an exemplary embodiment of the main frame of a vehicle configured for container-swapping according to an exemplary embodiment of the present disclosure, respectively;

FIG. 6 is a perspective view of a coupling portion included in a vehicle configured for container-swapping according to an exemplary embodiment of the present disclosure;

FIG. 7 is a perspective view of a driving portion included in a vehicle configured for container-swapping according to an exemplary embodiment of the present disclosure;

FIG. 8 is a top view exemplarily illustrating steering by a driving portion included in a vehicle configured for container-swapping according to an exemplary embodiment of the present disclosure;

FIG. 9A and FIG. 9B are side views exemplarily illustrating vehicle height control by a driving portion included in a vehicle configured for container-swapping according to an exemplary embodiment of the present disclosure;

FIG. 10A and FIG. 10B illustrate energy transfer paths during a collision of a vehicle configured for container-swapping according to an exemplary embodiment of the present disclosure; and

FIG. 11 illustrates the container module and the main frame of the vehicle in FIG. 2, which are coupled to each other.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments included in the present specification will be described in detail with reference to the accompanying drawings, and the same or similar elements are provided the same and similar reference numerals, so duplicate descriptions thereof will be omitted.

The terms “module” and “unit” used for the elements in the following description are provided or interchangeably used in consideration of only the ease of writing the specification, and do not have distinct meanings or roles by themselves.

In describing the exemplary embodiments included in the present specification, when the detailed description of the relevant known technology is determined to unnecessarily obscure the gist of the present disclosure, the detailed description may be omitted. Furthermore, the accompanying drawings are provided only for easy understanding of the exemplary embodiments included in the present specification, and the technical spirit included herein is not limited to the accompanying drawings, and it may be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

A conventional container moving vehicle is generally structured so that a driving portion is provided on the front portion of the main frame to drive the vehicle, and a container is coupled to the rear portion of the main frame.

To couple the container to the main frame of the vehicle in such a structure, a device for moving the container toward the main frame is necessary, posing a problem in that the main frame and the container cannot be coupled without such a device. Furthermore, because the container is positioned on the rear portion of the vehicle, the center of gravity is on the rear portion of the vehicle. As a result, the vehicle is easily turned upside down if the vehicle collides or slips, affecting neighboring vehicles as well.

To solve such problems, the present disclosure proposes a vehicle configured for container-swapping.

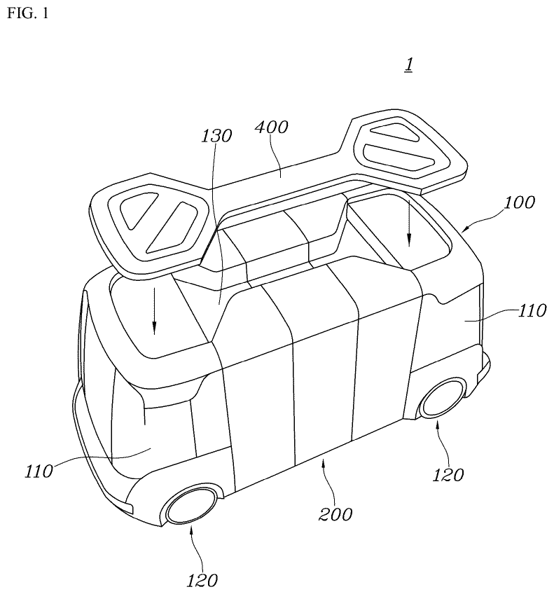

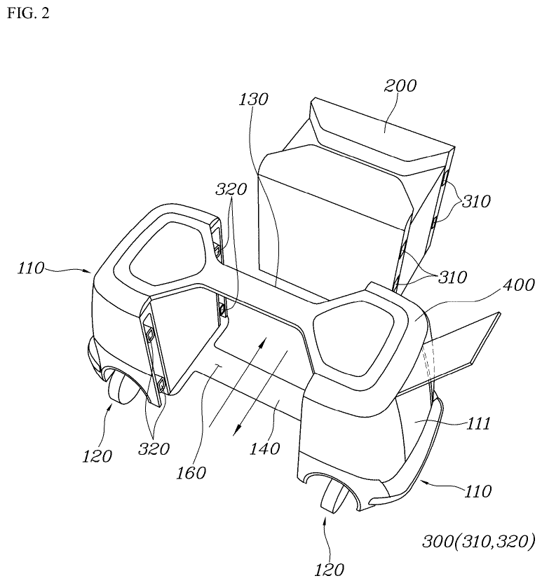

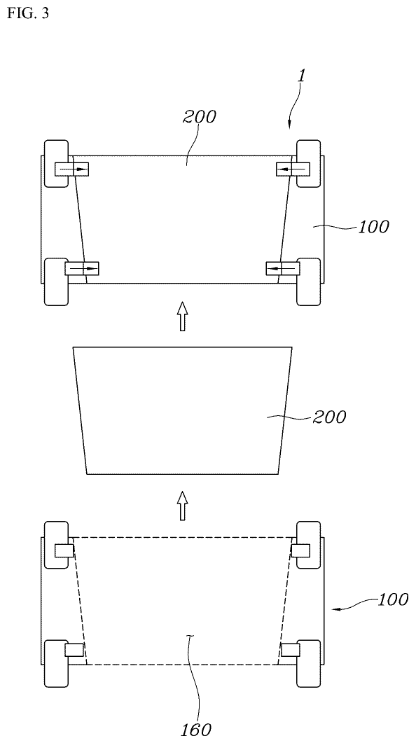

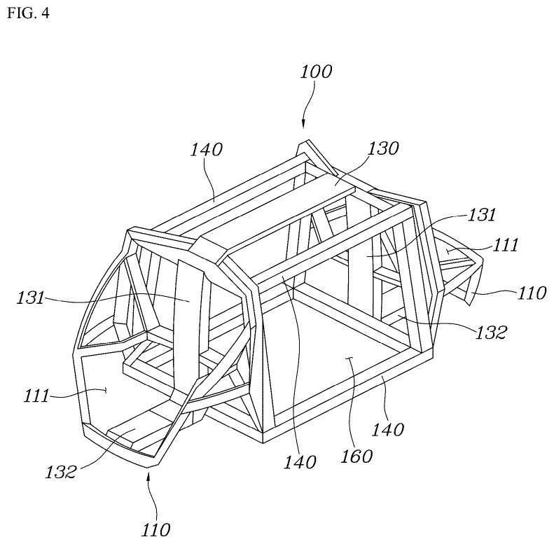

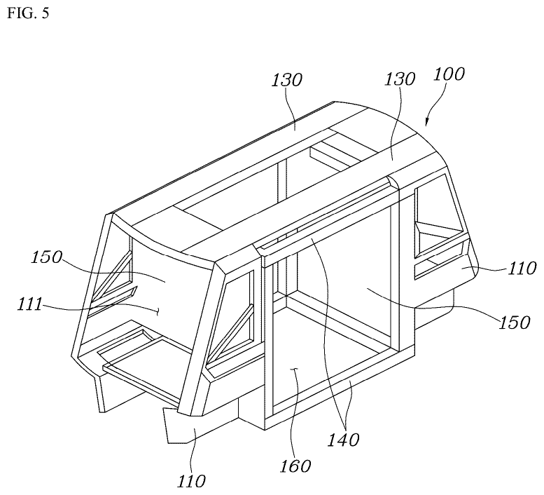

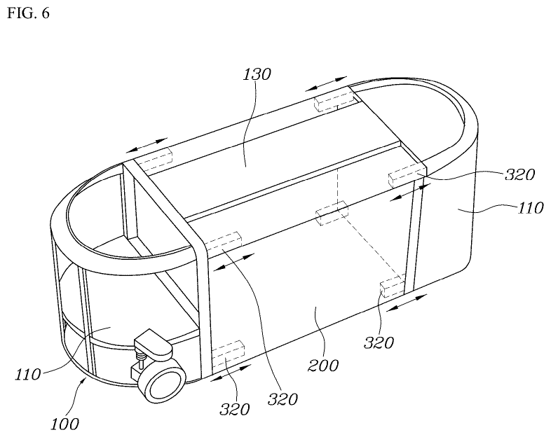

FIG. 1 is a perspective view of a vehicle 1 configured for container-swapping according to an exemplary embodiment of the present disclosure. FIG. 2 is a perspective view of a vehicle 1 configured for container-swapping according to an exemplary embodiment of the present disclosure, the container module 200 and main frame 100 of which are separated from each other. FIG. 3 is a top view exemplarily illustrating a process of coupling the container module 200 and main frame 100 of a vehicle 1 configured for container-swapping according to an exemplary embodiment of the present disclosure. FIG. 4 and FIG. 5 are perspective views of an exemplary embodiment of the main frame 100 of a vehicle 1 configured for container-swapping according to an exemplary embodiment of the present disclosure, respectively. FIG. 6 is a perspective view of a coupling portion 300 included in a vehicle 1 configured for container-swapping according to an exemplary embodiment of the present disclosure.

An exemplary embodiment of a vehicle 1 configured for container-swapping according to an exemplary embodiment of the present disclosure will now be described with reference to FIG. 1 to FIG. 6.

The vehicle 1 configured for container-swapping according to an exemplary embodiment of the present disclosure includes a main frame 100, a container module 200, and a coupling portion 300 configured to couple the container module 200 and the main frame 100 to each other.

As illustrated in FIG. 1 and FIG. 2, the main frame 100 may include a pair of drive modules 110 spaced in the forward/backward direction of the vehicle 1 and provided with driving portions 120, respectively, and a connecting portion 130 extending in the forward/backward direction of the vehicle 1 to connect the pair of drive modules 110, forming a coupling space therebetween. Only one of the pair of drive modules 110 may include the driving portion 120.

A pair of drive modules 110 may be provided to be symmetrical in the forward/backward direction with reference to the center portion of the vehicle 1, and may be manufactured in the same structure or partially different structures, depending on the design. The drive modules 110 may have a width corresponding to that of the vehicle 1.

Each drive module 110 may have a driving portion 120 for driving the vehicle 1, moving the main frame 100.

The connecting portion 130 for connecting the pair of drive modules 110 may be formed to extend in the forward/backward direction of the vehicle 1 so that both end portions thereof are coupled to the drive modules 110, respectively, forming the main frame 100. The length of the connecting portion 130 may be formed differently depending on the designer, and the entire length of the vehicle 1 may be configured by the length of the connecting portion 130.

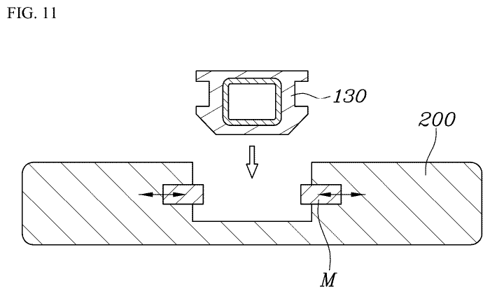

As illustrated in FIG. 1 and FIG. 2, the connecting portion 130 extends in the forward/backward direction of the vehicle 1 to connect the pair of drive modules 110 to each other, forming a coupling space 160 between the pair of drive modules 110, and a container may be inserted into the coupling space 160 of the main frame 100. When coupled as in the state illustrated in FIG. 2, the connecting portion 130 is inserted into a groove formed on the upper portion of the container module 200 as illustrated in FIG. 11, and lockers M are made to protrude from the container module 200 by electromagnets or the like and are coupled to the connecting portion 130, enhancing the coupling between the container module 200 and the pair of drive modules 110, and further guaranteeing the vehicle durability, performance, and the like.

As illustrated in FIG. 3, to insert the container module 200 into the coupling space 160 of the main frame 100, the driving portions 120 of the drive modules 110 may operate and move the main frame 100 toward the container module 200 so that the container module 200 is positioned in the coupling space 160.

The coupling portion 300 couples the main frame 100 and the container module 200 while the container module 200 is positioned in the coupling space 160 of the main frame 100 such that, when the driving portions 120 drive the vehicle 1, the container and the main frame 100 may be moved together.

Accordingly, when the main frame 100 and the container module 200 are coupled to each other, the main frame 100 is moved without a device for moving the container so that the container module 200 is inserted into the coupling space 160, and so that the main frame 100 and the container module 200 are coupled by the coupling portion 300.

As illustrated in FIG. 4 and FIG. 5, the connecting portion 130 may connect upper end portions of the pair of drive modules 110 so that the coupling space 160 is formed below the connecting portion 130.

The coupling space 160 may be open laterally, and the container module 200 may be inserted into the coupling space 160 through the open coupling space 160.

FIG. 4 illustrates various exemplary embodiments of the main frame 100. Referring to FIG. 4, the main frame 100 may further include a pair of bent portions 131 which are bent from both end portions of the connecting portion 130 in the upward/downward direction to contact with the front and rear portions of the container module 200, respectively.

The bent portions 131 may be bent downwards from both end portions of the connecting portion 130, respectively, and extension portions 132 may be formed integrally with the bent portions 131 in bridge shapes, respectively. When the container module 200 is inserted into the coupling space 160 of the main frame 100 and fixed to the coupling portion 300, both bent portions 131 may contact with the front and rear portions of the container module 200, respectively.

Accordingly, the bent portions 131 support the front and rear portions of the container module 200 when the vehicle 1 travels, improving stability during traveling, and the areas coupled with the drive modules 110 are expanded by the bent portions 131, improving the rigidity of the vehicle 1.

As illustrated in FIG. 4, the main frame 100 may further include a pair of extension portions 132 extending from end portions of the pair of bent portions 131 toward bumper portions of the drive modules 110, respectively.

The drive modules 110 may include bumper portions provided outwards to protect the vehicle 1, and the extension portions 132 may extend from end portions of the bent portions 131 toward the bumper portions of the vehicle 1, respectively. The extension portions 132, the bent portions 131, and the connecting portion 130 may be formed integrally.

As illustrated in FIG. 4 and FIG. 5, the main frame 100 may further include reinforcement portions 140 extending in the longitudinal direction of the vehicle 1 to additionally connect the drive modules 110.

The reinforcement portions 140 may extend in the longitudinal direction of the vehicle 1 while the pair of drive modules 110 remain connected to each other by the connecting portion 130, additionally connect the pair of drive modules 110.

The reinforcement portions 140 may thus additionally reinforce the vehicle rigidity.

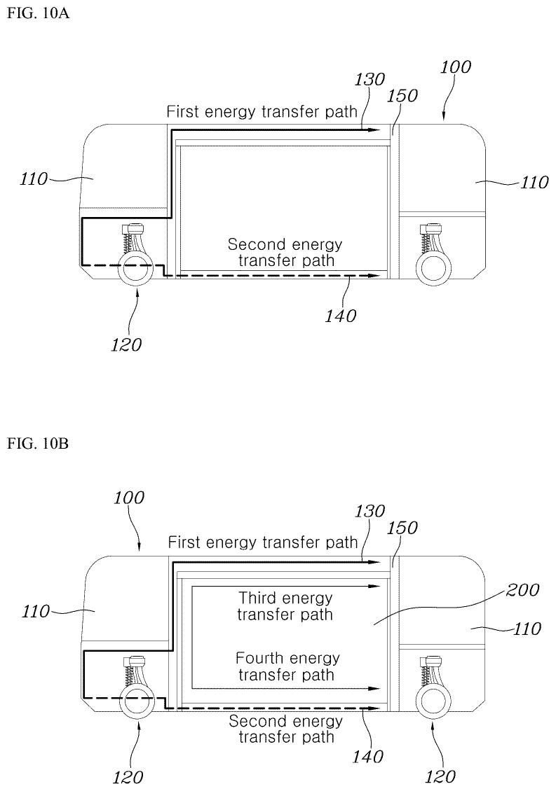

FIG. 10A and FIG. 10B illustrate energy transfer paths during a collision of a vehicle 1 configured for container-swapping according to an exemplary embodiment of the present disclosure.

FIG. 10A illustrates a path of collision energy when the container module 200 is not coupled to the main frame 100, and FIG. 10B illustrates a path of collision energy when the container module 200 is coupled to the main frame 100.

If a collision occurs while the container module 200 is not coupled to the main frame 100 as illustrated in FIG. 10A, the impact is transferred to the drive modules 110. The impact is then transferred to the opposite drive module 110 through the bent portions 131 and the connecting portion 130 (first energy transfer path), and through the reinforcement portions 140 (second energy transfer path). As a result, the degree of impact is reduced, reducing damages to the vehicle 1 and injury to the passengers.

If a collision occurs while the container module 200 is coupled as illustrated in FIG. 10B, the impact is distributed through upper and lower portions of the container module 200 (third and fourth energy transfer paths) in addition to the first and second energy transfer paths, reducing damages to the vehicle 1 and injury to the passengers.

FIG. 5 illustrates various exemplary embodiments of the main frame 100. Referring to FIG. 5, multiple connecting portions 130 may be formed and spaced apart in the transverse direction of the vehicle 1 to connect the drive modules 110.

According to the various exemplary embodiments of the main frame 100, multiple connecting portions 130 may be formed to connect the upper portions of the pair of drive modules 110 and may be spaced apart in the leftward/rightward direction of the vehicle 1 to connect the drive modules 110, improving the rigidity of the main frame 100.

Referring to FIG. 5, in the various exemplary embodiments of the main frame 100, the main frame 100 may include barrier portions 150 formed such that, when the container module 200 is coupled thereto, the front and rear surfaces of the container module 200 contact with the same.

The barrier portions 150 may be formed on parts supposed to contact with the drive modules 110 when the container module 200 is coupled in the coupling space 160, and may absorb impact energy transferred through an energy transfer path during a front or rear-end collision of the vehicle 1, minimizing damages to the vehicle 1 and injury to passengers.

Referring to FIG. 2 and FIG. 6, the coupling portion 300 may further include insertion grooves 310 and actuators 320 formed on facing surfaces of the drive modules 110 and the container module 200. The insertion grooves 310 may be formed on one of the drive modules 110 and the container module 200, and the actuators 320 may be formed on the other thereof so that the actuators 320 operate to be inserted into the insertion grooves 310.

The coupling portion 300 for coupling the main frame 100 and the container module 200 may be provided on coupling surfaces of the main frame 100 and the container module 200. The coupling portion 300 may include insertion grooves 310 formed on one of two surfaces of the main frame 100 and the container module 200, which contact each other, and actuators 320 formed on the other surface to slide to be inserted into the insertion grooves 310.

The actuators 320 may operate to be inserted into the insertion grooves 310, after the container module 200 is fully inserted into the coupling space 160 so that the main frame 100 and the container module 200 are coupled.

The actuators 320 may include magnetic modules configured to retain the insertion grooves 310 and the actuators 320 by magnetic forces through a magnetic circuit change so that the actuators 320 are retained after sliding into the insertion grooves 310.

The insertion grooves 310 may be provided on the container module 200, and the actuators 320 may be provided on the drive modules 110.

As illustrated in FIG. 2, the insertion grooves 310 may be provided on the container module 200, and the actuators 320 may be provided on the drive modules 110. Accordingly, the actuators 320 may be operated by electric power applied from high-voltage batteries provided in the drive modules 110 under the control of the drive modules 110.

The above disposition of the insertion grooves 310 and the actuators 320 is only an example, and the positions thereof may be switched.

Coupling portions 300 may be provided on corner portions of facing surfaces of the drive modules 110 and the container module 200, respectively.

As illustrated in FIG. 6, multiple coupling portions 300 may be provided on corner portions of facing surfaces of the drive modules 110 and the container module 200, respectively.

This may enhance the robustness in coupling between the container module 200 and the main frame 100 and may alleviate spinning of the vehicle 1 due to the weight of the container module 200 when the vehicle 1 rotates.

The coupling portions 300 may electrically connect the main frame 100 and the container module 200.

The coupling portions 300 may connect the main frame 100 and the container module 200 to each other both mechanically and electrically so that electric power is input from the main frame to the container 200 and used, or electric power is input from the container 200 to the main frame 100.

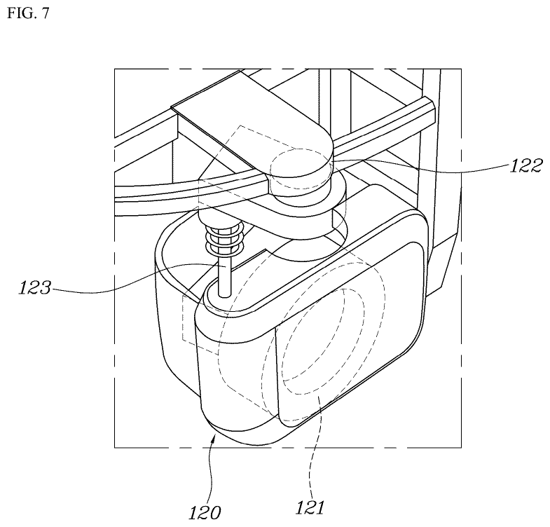

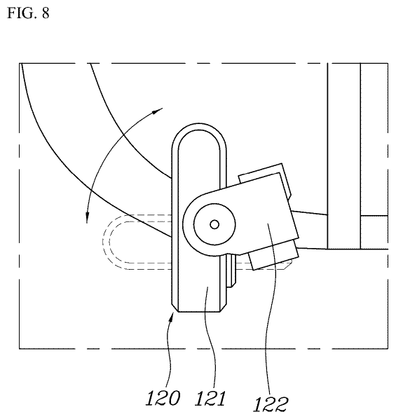

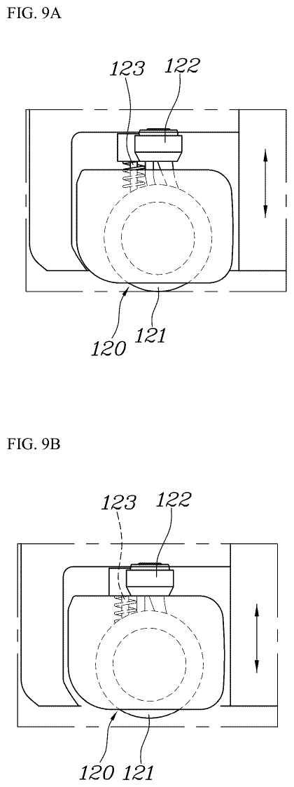

FIG. 7 is a perspective view of a driving portion 120 included in a vehicle 1 configured for container-swapping according to an exemplary embodiment of the present disclosure. FIG. 8 is a top view exemplarily illustrating steering by a driving portion 120 included in a vehicle configured for container-swapping according to an exemplary embodiment of the present disclosure. FIG. 9A and FIG. 9B are side views exemplarily illustrating vehicle height control by a driving portion 120 included in a vehicle 1 configured for container-swapping according to an exemplary embodiment of the present disclosure.

The driving portion 120 may be formed as an independent driving module.

Referring to FIG. 7, drive modules 120 provided symmetrically with each other may have driving portions 120 configured to operate independently (independent driving modules), respectively so that the drive modules 110 can travel forwards and backwards thereof.

Each driving portion 120 may include a steering device 122 configured to rotate a wheel 121 of the vehicle 1 around a rotation axis thereof in the upward/downward direction so that the vehicle can travel laterally.

Referring to FIG. 8, each driving portion 120 formed as an independent driving module may have a steering device 122 configured for rotating the wheel 121 by 90° or more such that, by rotating all wheels 121 of the vehicle 1 by 90°, the vehicle 1 can travel laterally.

As illustrated in FIG. 3, the main frame 100 can travel laterally so that the container module 200 may be inserted into the coupling space 160.

Accordingly, the main frame 100 and the container module 200 may be coupled solely by a movement of the main frame 100 without a separate device for moving the container module 200.

Each driving portion 120 may include a vehicle height adjusting portion 123 for adjusting the vehicle height of the main frame 100 such that, when the container module 200 and the main frame 100 are coupled, the vehicle height is lowered, and when the container module 200 and the main frame 100 are fully coupled, the vehicle height is raised.

As illustrated in FIG. 9A and FIG. 9B, the vehicle height adjusting portion 123 for adjusting the vehicle height may lower the vehicle height when the main frame 100 and the container module 200 are coupled to each other, as illustrated in FIG. 9A so that the main frame 10 corresponds to the container module 200, and may raise the vehicle height when the coupling is completed so that the vehicle 1 can travel smoothly.

Each drive module 110 may have an indoor space 111 for accommodating a passenger or containing a battery for supplying electric power to the driving portion 120.

As illustrated in FIG. 2, the indoor spaces 111 provided in the drive modules 110 may accommodate the driver of the vehicle 1, passengers, batteries, or motors of the driving portions 120.

Furthermore, a roof panel 400 may extend in the forward/backward direction of the vehicle 1 to cover the upper portion of the main frame 100.

The roof panel 400 may cover both the upper portion of the main frame 100 and an electric wire disposed along the connecting portion 130 to electrically connect the pair of drive modules 110.

The roof panel 400 may have an air-conditioning duct provided thereon so that a single air-conditioning device connects the pair of drive modules 110, operating the air-conditioning system of the pair of drive modules 110.

In an exemplary embodiment of the present disclosure, a controller is connected to at least one of the elements of the vehicle such as vehicle height adjusting portion 123 to control the operations thereof.

In addition, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method disclosed in the aforementioned various exemplary embodiments of the present invention.

The aforementioned invention can also be embodied as computer readable codes on a computer readable recording medium. The computer readable recording medium is any data storage device that can store data which can be thereafter read by a computer system and store and execute program instructions which can be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code that may be executed by a computer using an interpreter or the like.

In an exemplary embodiment of the present invention, each operation described above may be performed by a control device, and the control device may be configured by multiple control devices, or an integrated single control device.

In an exemplary embodiment of the present invention, the scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

In an exemplary embodiment of the present invention, the control device may be implemented in a form of hardware or software, or may be implemented in a combination of hardware and software.

In addition, the terms such as “unit”, “module”, etc. disclosed in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle configured for container-swapping, the vehicle comprising:
a main frame including a pair of drive modules spaced in a longitudinal direction of the vehicle, and a connecting portion extending in the longitudinal direction of the vehicle to connect the pair of drive modules so that a coupling space is formed therebetween;
a container module selectively inserted into the coupling space of the main frame; and
a coupling portion configured to couple the main frame and the container module to each other while the container module is inserted into the coupling space of the main frame,
wherein at least one of the pair of drive modules includes a driving portion configured to move the main frame so that the container module is inserted into the coupling space of the main frame.

2. The vehicle of claim 1, wherein the connecting portion connects upper end portions of the pair of drive modules, and the main frame further includes a pair of bent portions bent in a predetermined direction from first and second end portions of the connecting portion, respectively and to contact front and rear portions of the container module, respectively.

3. The vehicle of claim 2, wherein the main frame further includes a pair of extension portions extending from end portions of the pair of bent portions toward bumper portions of the drive modules, respectively.

4. The vehicle of claim 2, wherein the main frame further includes a reinforcement portion extending in a longitudinal direction of the vehicle to additionally connect the drive modules.

5. The vehicle of claim 2, wherein a plurality of connecting portions is formed to be spaced apart in a transverse direction of the vehicle, connecting the drive modules.

6. The vehicle of claim 1, wherein the main frame includes a barrier portion formed so that, when the container module is coupled, front and rear surfaces of the container module make contact therewith.

7. The vehicle of claim 1, further including:
coupling portions formed on facing surfaces of the drive modules and the container module, respectively; and
insertion grooves formed on one of the drive modules and the container module and actuators formed on another of the drive modules to operate to be inserted into the insertion grooves.

8. The vehicle of claim 7, wherein the insertion grooves are provided on the container module, and the actuators are provided on the drive modules.

9. The vehicle of claim 7, wherein the coupling portions are provided on corner portions of the facing surfaces of the drive modules and the container module, respectively.

10. The vehicle of claim 1, wherein the driving portion is formed as an independent driving module.

11. The vehicle of claim 10, wherein the driving portion includes a steering device configured to rotate a vehicle wheel around a rotation axis thereof in an upward and downward direction so that the vehicle can travel laterally.

12. The vehicle of claim 10, wherein the driving portion includes a vehicle height adjusting portion configured to adjust a vehicle height of the main frame so that, when the container module and the main frame are coupled, the vehicle height adjusting portion is configured to lower the vehicle height, and when the container module and the main frame are fully coupled, the vehicle height adjusting portion is configured to raise the vehicle height.

13. The vehicle of claim 1, wherein each drive module includes an indoor space therein to accommodate a passenger or a battery for supplying power to the driving portion.

14. The vehicle of claim 1, further including a roof panel extending in the longitudinal direction of the vehicle to cover an upper portion of the main frame.

15. The vehicle of claim 1, wherein the coupling portion is configured to electrically connect the main frame and the container module.
